(19) United States
(12) Patent Application Publication
(10) Pub. No.: US 2009/0169717 A1
(43) Pub. Date: Jul. 2, 2009

(54) Liquid crystal depositing device and method

(75) Inventors: Mingting Wen, KunShan City (CN); Jian Zhu, Kunshan City (CN); Qinghua Zhu, Kunshan City (CN)

Correspondence Address: CALFEE HALTER & GRISWOLD, LLP, 800 SUPERIOR AVENUE, SUITE 1400, CLEVELAND, OH, 44114, US

(73) Assignee: InfoVision Optoelectronics (Kunshan) Co. Ltd., KunShan City (CN)

(21) Appl. No.: 12/286,242

(22) Filed: Sep. 29, 2008

(30) Foreign Application Priority Data
Dec. 26, 2007 (CN) 200710305236.6

(51) Int. Cl. B05D 1/02; B05C 11/10

(52) U.S. Cl. 427/8; 118/708

(57) ABSTRACT

Liquid crystal depositing devices and methods that monitor the amount of the liquid crystal available for dispensing and supplement the liquid crystal when the device detects that the amount available is running low. One exemplary liquid crystal depositing device includes a liquid crystal dispensing container, a liquid crystal nozzle, a liquid crystal sensor, and a liquid crystal supplementing container. The liquid crystal nozzle deposits the liquid crystal from said liquid crystal container to the liquid crystal display substrate. The liquid crystal sensor is configured to monitor an amount of liquid crystal inside the liquid crystal dispensing container. The liquid crystal supplementing container is configured to supply liquid crystal to the liquid crystal dispensing container when the liquid crystal sensor detects that the amount of liquid crystal in the dispensing container has fallen below a predetermined amount. In one exemplary method, a detected amount of liquid crystal in a liquid crystal dispensing container is compared to a predetermined sufficient liquid crystal amount. The liquid crystal in the liquid dispensing crystal container is supplemented when the liquid crystal amount in the liquid crystal dispensing container is below the predetermined sufficient liquid crystal amount. The liquid crystal is deposited onto a liquid crystal display substrate when the liquid crystal amount in the liquid crystal dispensing container is above the predetermined sufficient liquid crystal amount.

### CROSS-REFERENCE TO RELATED APPLICATION

This application claims priority to prior Chinese Application Serial No. 200710305236.6, filed Dec. 26, 2007, the disclosure of which is hereby incorporated herein by reference in its entirety.

### TECHNICAL FIELD

The present invention relates to the field of liquid crystal displays, and in particular to a liquid crystal depositing device and a method of depositing liquid crystal in the manufacture of liquid crystal displays.

### BACKGROUND

Traditional cathode ray tube displays are substituted gradually by liquid crystal displays due to the advantages of liquid crystal displays. For example, liquid crystal displays are light weight and thin; they use less power than cathode ray tubes; they do not emit radiation; and they have other advantages. Currently, the liquid crystal displays are used widely in electronic products, such as high quality digital televisions, desktop computers, personal digital assistants, laptop computers, digital cameras and mobile telephones, and the like.

The manufacture of the liquid crystal display generally comprises the following processes: an array process for disposing, for example, TFT (Thin Film Transistor) buses or switch devices on a TFT substrate (i.e. the switch devices from an active matrix on the TFT substrate); a color filter (hereinafter, simplified as CF) process for disposing color filter sheets on a CF substrate; a liquid crystal cell process for assembling the two substrates into a single panel; and a module process for assembling driver integrated circuits (ICs) and a back light.

The liquid crystal cell process is a procedure for assembling together the TFT substrate and the CF substrate which are produced in the array process and the color filter process, respectively. A fixed small gap is disposed normally between the TFT substrate and the CF substrate in an empty liquid crystal cell, and a liquid crystal panel is produced by filling liquid crystal into an opening to the gap.

Normally, a liquid crystal vacuum filling method is used to fill the liquid crystal into an empty liquid crystal cell. FIG. 1 is a schematic diagram describing the principle of the liquid crystal vacuum filling method. As shown in FIG. 1, the liquid crystal 25 is disposed inside a container 30 within a chamber 20. The chamber 20 is maintained in a vacuum state by using a vacuum pump in order to remove the water and air which are dissolved in the liquid crystal 25 or contained in the container 30. A filling hole for filling the liquid crystal is disposed in an empty liquid crystal cell 40, and the filling hole is dipped in the container 30 and contacts with the liquid crystal 25. When operating, the nitrogen gas N₂ is directed into the chamber 20 to change the state of the cavity 20 from a high vacuum state to a lower vacuum state, and finally to an atmospheric pressure state, so the liquid crystal 25 is filled into the liquid crystal cell 40 via the liquid crystal filling hole under the pressure difference between the pressure in the liquid crystal cell 40 and that in the cavity 20. After the filling is completed, the liquid crystal filling hole is sealed and the liquid crystal cell is cleaned to form a final liquid crystal panel.

The principle of said method above is simple, and it can be implemented easily, however, the following problems exist in said liquid crystal vacuum filling method. Firstly, the time required for filling the liquid crystal into the liquid crystal cell is rather long. Normally, the width of the gap between the TFT substrate and the CF substrate in the liquid crystal display panel is very narrow, and the gap width is on the order of micron. Therefore, in method, the quantity of the liquid crystal, which is filled into the liquid crystal panel, is very small, but the time required to do so is great. For example, during the manufacturing procedure for a 15 inch liquid crystal display panel, 8 hours is required for completing the filling of the liquid crystal. As a result, the time for manufacturing the liquid crystal panel is too long.

Secondly, the wastage of the liquid crystal in the method is rather large. Only a small amount of the liquid crystal in the container can be filled into the liquid crystal panel.

Thirdly, the method increases the manufacturing cost of the liquid crystal panel. When the liquid crystal is exposed to air or other gasses, the liquid crystal may react with the air or gas and be polluted or contaminated. Therefore, in the method, after the filling of the liquid crystal is completed, the residual liquid crystal is discarded, which increases manufacturing costs.

A method of depositing liquid crystal on a substrate in drops (referred to herein as “dropping”) has been developed to reduce some of the shortcomings of the vacuum filling method. The liquid crystal layer is formed according to this method by directly depositing the liquid crystal in drops (“dropping”) onto the substrate or the CF substrate, then the TFT substrate is pressed together with CF substrate during the assembly procedure of the substrates to allow the liquid crystal on the substrates to be diffused across the entire panel.

FIG. 2 is a schematic diagram describing the principle of the liquid crystal dropping method. As shown in FIG. 2, the liquid crystal in a liquid-drop shape is dropped or deposited onto a substrate 405 provided with a driver device thereon, and a seal material 409 is applied to the outside edge of another substrate 403 provided with a color filter thereon. The substrate 405 and the substrate 403 are pressed to allow the substrate 405 and the substrate 403 to be bonded together with the edge sealed. Meanwhile, the internal liquid crystal drops 407 are diffused due to the pressure. As a result, a liquid crystal layer having a uniform thickness is formed between the substrate 403 and the substrate 405. Similarly, if the substrate 403 is disposed below, the liquid crystal 407 can also be dropped onto the substrate 403. That is, the liquid crystal can be dropped onto a TFT substrate or a CF substrate before the liquid crystal panel is assembled.

FIG. 3 is a structure schematic diagram of a conventional liquid crystal depositing device for implementing the liquid crystal dropping method as shown in FIG. 2. As shown in FIG. 3, the liquid crystal 302 is put inside a bottle-shaped liquid crystal container 301. A dropper 304 or depositing nozzle is inserted into the liquid crystal container 301 to form a pipeline, through which the liquid crystal flows. A pump 305 and a filter 303 are also provided in the pipeline. The pump 305 is used for pumping the liquid crystal 302 inside the liquid crystal container 301 to cause it to flow out from an exit of the pipeline. The filter 303 is used for filtering the liquid crystal dispensed by the pipeline to ensure the quality of the liquid crystal which is to be deposited in the liquid crystal panel.

According to the dropping method implemented by the device as shown in FIG. 3, the liquid crystal can be deposited directly onto the substrate in a very short time period. As a result, the liquid crystal layer can be formed rapidly on a large area of the liquid crystal panel. Furthermore, the amount of liquid crystal that is wasted in the method is rather small, and the cost of manufacturing the liquid crystal panel is decreased as compared to the vacuum filling method.

### SUMMARY

Embodiments of the present invention include liquid crystal depositing devices and depositing methods. In one embodiment, a liquid crystal depositing device can monitor the amount of the liquid crystal available for dispensing and supplement the liquid crystal when the device detects that the amount available is running low.

According to one embodiment, a liquid crystal depositing device is provided. The liquid crystal depositing device includes a liquid crystal dispensing container, a liquid crystal nozzle, a liquid crystal sensor, a liquid crystal supplementing container, and a liquid crystal transferring tube. The liquid crystal dispensing container contains liquid crystal to be deposited onto a liquid crystal display substrate. The liquid crystal nozzle deposits the liquid crystal from the liquid crystal container to the liquid crystal display substrate. The liquid crystal sensor is configured to monitor an amount of liquid crystal inside the liquid crystal dispensing container. The liquid crystal supplementing container is configured to supply liquid crystal to the liquid crystal dispensing container when the liquid crystal sensor detects that the amount of liquid crystal in the dispensing container has fallen below a predetermined amount. The liquid crystal transferring tube connects the liquid crystal supplementing container with the liquid crystal dispensing container to facilitate the transfer of the liquid crystal.

According to another embodiment, a method of depositing liquid crystal is provided. An amount of liquid crystal in a liquid crystal dispensing container is detected. The detected amount of liquid crystal in the liquid crystal dispensing container is compared to a predetermined sufficient liquid crystal amount. The liquid crystal in the liquid crystal dispensing container is supplemented when the liquid crystal amount in the liquid crystal dispensing container is below the predetermined sufficient liquid crystal amount. The liquid crystal is deposited onto a liquid crystal display substrate when the liquid crystal amount in the liquid crystal dispensing container is above the predetermined sufficient liquid crystal amount.

### BRIEF DESCRIPTION OF THE DRAWINGS

FIG. 1 is a schematic diagram showing the principle of a liquid crystal vacuum filling method.

FIG. 2 is a schematic diagram showing the principle of a liquid crystal dropping and adding method.

FIG. 3 is a schematic diagram of a conventional liquid crystal dropping device for implementing the liquid crystal dropping and adding method as shown in FIG. 2.

FIG. 4 is a schematic diagram of a liquid crystal depositing device according to an embodiment of the present invention.

FIG. 5(a) and FIG. 5(b) are flow charts showing the depositing of the liquid crystal implemented by the liquid crystal dropping device of FIG. 4.

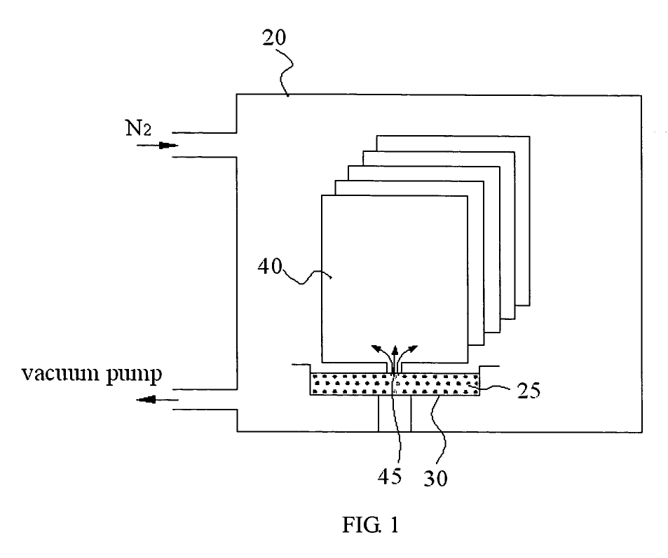

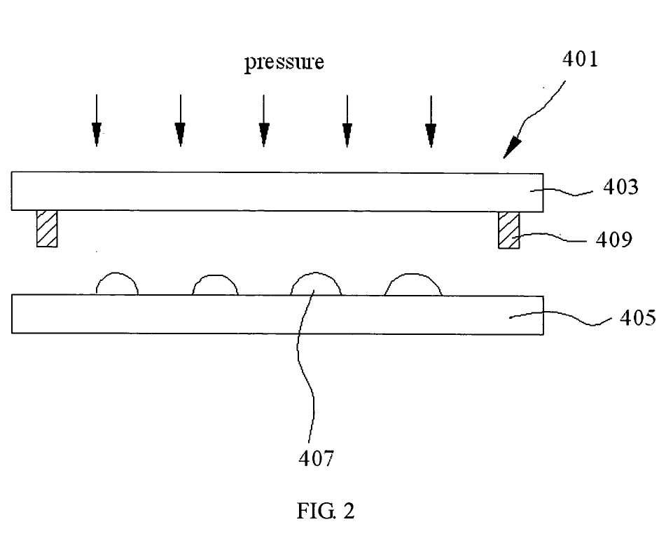

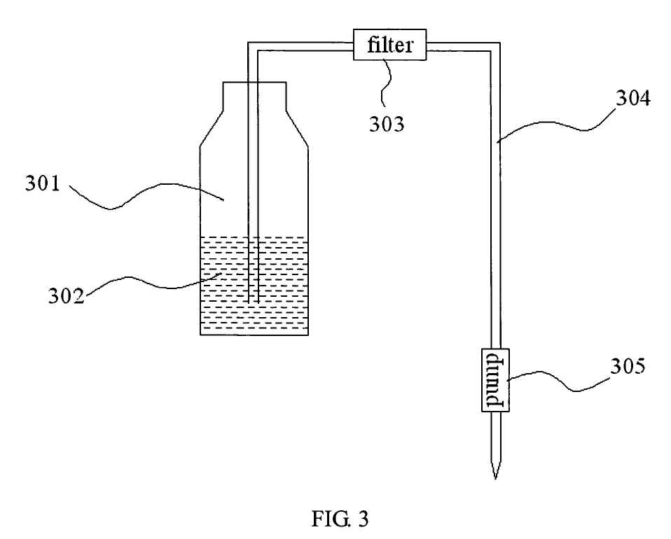

### DETAILED DESCRIPTION OF THE INVENTION

It should be readily understood that the liquid crystal depositing device and the depositing method of the present invention can take a wide variety of different forms and steps. The following drawings illustrate specific embodiments that are only examples for describing the technical scheme of the present invention. However, these descriptions of exemplary depositing methods and depositing devices are not intended to limit the scope of the present invention. The various aspects of the disclosed exemplary embodiments may be realized in many alternative embodiments, either individually or in various combinations and subcombinations thereof. Unless expressly excluded herein all such combinations and subcombinations are intended to be within the scope of the present invention.

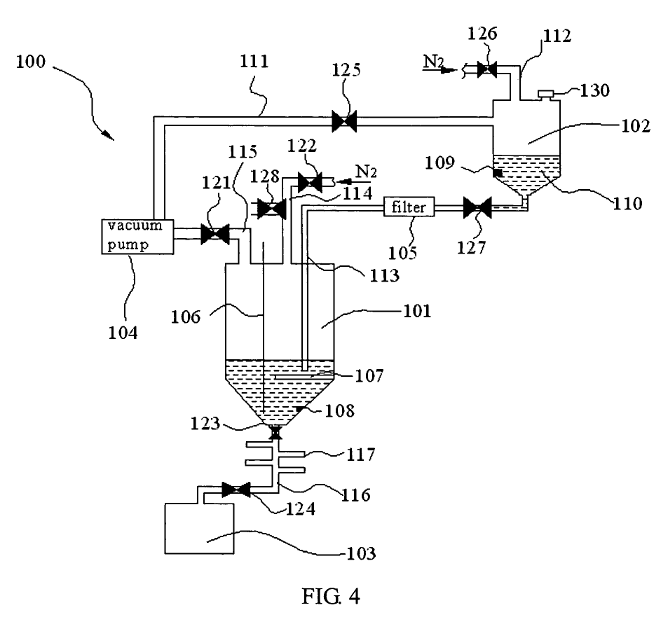

FIG. 4 is a schematic diagram of a device for depositing liquid crystal. In one embodiment, the device depositing the liquid crystal in drops. However, the device may deposit the liquid crystal in any controlled manner. For example, the device may deposit the liquid crystal to a substrate in any pattern, such as a pattern of lines, curves, drops or any combination thereof. As shown in FIG. 4, the liquid crystal depositing device 100 of the present invention comprises a liquid crystal dispensing container 101, a liquid crystal supplementing container 102 and a waste liquid crystal recycle container 103.

As shown in FIG. 4, the liquid crystal dispensing container 101 may be a container having an upside down taper bottom structure. The container may also have a wide variety of different shapes. A measurement device 106 is inserted into the liquid crystal dispensing container 101 through the upper portion of the liquid crystal dispensing container 101 and is disposed as near as possible to the upside down taper bottom structure of the liquid crystal dispensing container 101. The measurement device 106 measures a property of the liquid crystal, such as purity. In an exemplary embodiment, the measurement device 106 is used for observing the resistance value of the liquid crystal (Normally, the resistivity is used as a characteristic value for the purity of the liquid crystal, that is, it reflects the quantity of the impurity ions in the liquid crystal, and the resistivity of the liquid crystal used in a liquid crystal panel is larger than 10¹³Ω.cm, normally). However, the measurement device 106 may measure other properties of the liquid crystal that are indicative of the purity of the liquid crystal. By monitoring the liquid crystal in the liquid crystal dispensing container 101 just before it is deposited onto the liquid crystal panel, it can be ensured that the deposited liquid crystal has a high purity and therefore the liquid crystal deposited to the liquid crystal panel conforms to the basic requirement of liquid crystal purity. When the liquid crystal resistivity measured by the measurement device 106 is lower than the specific requirement for deposited liquid crystal purity, an instruction to stop the depositing will be issued by a control system (not shown) of the depositing device, and the liquid crystal which does not conform to the deposited liquid crystal purity requirement is recycled to the waste liquid crystal recycle container 103.

A first sensor 108 detects the residual liquid crystal amount in the liquid crystal dispensing container 101, which may have an upside down taper shape. The first sensor 108 may take a wide variety of different forms. In one embodiment, the first sensor 108 is an inductor. However, any sensor capable of detecting the amount of liquid crystal remaining in the container 101 can be used. In one embodiment, the first sensor 108 detects when the amount of liquid crystal in the dispensing container 101 has fallen below a predetermined amount or level. In the embodiment illustrated by FIG. 4, the first sensor 108 is disposed at a lower position of one side wall of the liquid crystal dispensing container 101. In the embodiment illustrated by FIG. 4, when the level of the liquid crystal in the liquid crystal dispensing container 101 is lower than the position where the first sensor 108 is located, an alert signal that the liquid crystal in the liquid crystal dispensing container 101 is insufficient will be issued by the first sensor 108 to the control system (not shown) of the depositing device in order to supply or supplement the liquid crystal to the liquid crystal dispensing container 101, before the container 108 is completely emptied.

A liquid crystal transferring tube 113, a second gas supplying tube 114 and a second vessel 115 or a pipeline are disposed at the upper portion of the liquid crystal dispensing container 101. One end of the liquid crystal transferring tube 113 is connected to the bottom of the liquid crystal supplementing container 102, and the other end is connected to a portion in the liquid crystal dispensing container 101 near the bottom. When an alert signal that the liquid crystal in the liquid crystal dispensing container 101 is low is issued by the first sensor 108, an instruction will be issued by the control system (not shown) of the depositing device to control the liquid crystal supplementing container 102 to supplement the liquid crystal of the liquid crystal dispensing container 101.

Furthermore, a filter 105 and a valve assembly 127 for controlling whether a pipeline of the liquid crystal transferring tube 113 is ON to permit flow of liquid crystal or OFF to block flow of liquid crystal are disposed in the pipeline of the liquid crystal transferring tube 113. When the valve assembly 127 is ON or enabled, the liquid crystal in the liquid crystal supplementing container 102 is input into the liquid crystal dispensing container 101 via the filter 105. As a result, any impurities mixed in the liquid crystal may be filtered, and the liquid crystal having high purity can be supplied to the liquid crystal dispensing container 101.

A baffle 107 extending horizontally from the side wall inside the liquid crystal dispensing container 101 is disposed at the bottom of the liquid crystal transferring tube 113 such that a small distance is between the end of the tube 113 and the baffle 102. When the liquid crystal is dropped to the liquid crystal dispensing container 101 through the liquid crystal transferring tube 113, the baffle 107 can ensure that the disturbance of the liquid crystal in the liquid crystal dispensing container 101 is very small to thereby insure that the liquid crystal will not splash when it enters the liquid crystal dispensing container 101. The baffle 107 can be replaced with any arrangement or device that reduces or eliminates disturbances caused by transferring liquid crystal from the tube 113 into the dispensing container 101.

The second gas supplying tube 114 of the liquid crystal dispensing container 101 is connected with a gas supplying unit (not shown). When the liquid crystal is dispensed, a valve assembly 122 is enabled, and the inert gas, such as nitrogen (N₂) or the like, is filled into a space above the liquid crystal in the liquid crystal dispensing container 101. This filling with an inert gas it has the function of protecting the liquid crystal. Furthermore, the valve assembly 122 is disposed in the pipeline of the second gas supplying tube 114 and functions as an open or close control of the pipeline of the second gas supplying tube 114. When the valve assembly 122 is opened, the inert gas is filled into the liquid crystal dispensing container 101 by the gas supplying unit. A pressure release valve 128 is also connected with the second gas supplying tube 114 and is used for releasing the pressure of the liquid crystal dispensing container 101. The control system (not shown) of the depositing device issues an instruction to open the pressure release valve 128 when the pressure in the liquid crystal dispensing container 101 is too much, thereby the normal gas pressure range can be ensured to be maintained in the liquid crystal dispensing container 101. A second vessel or pipeline 115 of the liquid crystal dispensing container 101 is connected with a vacuum pump 104 and a valve assembly 121 is disposed in the pipeline of the second vessel 115 for opening or closing the pipeline of the second vessel 115. Under certain conditions, bubbles or vapor in the container may be mixed with the liquid crystal. In an exemplary embodiment, when this mixing occurs, the control system (not shown) of the depositing device will open the valve assembly 121 in the pipeline of the second vessel 115, and the liquid crystal in the liquid crystal dispensing container 101 will be subjected to a deaeration process by the vacuum pump 104, and the bubble or vapor being mixed with the liquid crystal is released from the liquid crystal dispensing container 101 through the second vessel or pipeline 115.

An optional liquid crystal dropper or nozzle manifold 116 is disposed at the bottom end of the liquid crystal dispensing container 101 having an upside down taper shape. The liquid crystal dropper 116 or nozzle manifold is connected with the liquid crystal dispensing container 101, and opening or closing of the pipeline is controlled by a first valve assembly 123. A plurality of liquid crystal branch droppers or nozzles 117 extending outwardly are disposed in the branch of the liquid crystal dropper or nozzle manifold 116. A pump and a dropper or nozzle opening (both not shown) are disposed on each of the liquid crystal branch droppers or nozzles 117. As such, the liquid crystal depositing device 100 of the present invention can deposit the liquid crystal to a plurality of liquid crystal panels via the plurality of liquid crystal branch droppers or nozzles 117 simultaneously. That is, the liquid crystal can be supplied to the plurality of liquid crystal branch droppers or nozzles by a single liquid crystal container in the present invention. As a result, the time for depositing the liquid crystal can be reduced so that the productivity can be increased. In another embodiment, the depositing device 100 includes a single outlet dropper or nozzle.

As described above, when the amount of liquid crystal in the liquid crystal dispensing container 101 is insufficient, the control system (not shown) of the dropping device opens the valve assembly 127. For example, the valve assembly 127 may be opened when the level or amount of liquid crystal sensed by the sensor 108 is below a predetermined level or amount. When the valve assembly 127 is opened, the liquid crystal of the liquid crystal supplementing container 102 is transferred into the liquid crystal dispensing container 101 via the liquid crystal transferring tube 113. The liquid crystal supplementing container 102 of the present invention will be described in detail together with the drawings as follows.

With further reference to FIG. 4, the liquid crystal supplementing container 102 is filled with the liquid crystal 110 for replenishing the first container 101. The liquid crystal supplementing container 102 is connected with a first vessel or pipeline 111 and a first gas supplying tube 112. The first vessel or pipeline 111 is connected with the vacuum pump 104, and the valve assembly 125 that is disposed in the pipeline of the first vessel 111. The valve assembly 125 controls opening or closing of the pipeline 111. When the valve assembly 125 is open, the liquid crystal 110 in the liquid crystal supplementing container 102 is deaerated by the vacuum pump 104, and any bubbles or vapor in the container 102 are released through the first vessel 111. As a result, the bubbles and the vapor of the liquid crystal in the liquid crystal supplementing container 102 are removed.

A first gas supplying tube 112 is connected with a gas supplying unit (not shown), and a valve assembly 126 is disposed in the pipeline of the first gas supplying tube 112 for controlling opening or closing of the pipeline of the first gas supplying tube 112.

A second sensor 109 is disposed at a side wall near the bottom of the liquid crystal supplementing container 102. The second sensor monitors the residual liquid crystal amount in the liquid crystal supplementing container 102. The second sensor 109 can take a wide variety of different forms. Any sensor capable of detecting a level of the liquid crystal in the supplementing container 102 can be used. In an exemplary embodiment, the second sensor may be an inductor.

A seal lid 130 is disposed on the top end of the liquid crystal supplementing container 102 to seal the container and prevent contaminants from entering the container. Liquid crystal can be added to the liquid crystal supplementing container 102 by opening the seal lid 130. When the surface level of the liquid crystal in the liquid crystal supplementing container 102 is lower than the position where the second sensor 109 is located, an alert signal that the residual liquid crystal amount in the liquid crystal supplementing container 102 is insufficient or is close to being insufficient may be issued by the control system (not shown) of the depositing device. When such a signal is provided by the sensor 109, the seal lid 130 may be opened and liquid crystal may be added into the liquid crystal supplementing container 102 to bring the level of liquid crystal back to an acceptable level. When enough of the liquid crystal has been added, an instruction for enabling the valve assembly 125 is issued by the control system (not shown) of the depositing device, and the liquid crystal 110 in the liquid crystal supplementing container 102 will be subjected to a deaeration process by the vacuum pump 104. After completing the deaeration process, an instruction is issued by the control system (not shown) of the depositing device to close the valve assembly 125 and to open the valve assembly 126 so that the inert gas, such as nitrogen, is filled into the liquid crystal supplementing container 102.

In order to recycle the liquid crystal in the liquid crystal dispensing container 101 which does not conform to the purity requirement, or to recycle the residual liquid crystal after completing the depositing, the waste liquid crystal recycle container 103 is connected with the liquid crystal dispensing container 101 via a liquid crystal nozzle or conduit 116. A second valve assembly 124 is disposed on the liquid crystal nozzle or conduit 116 near the inlet or port of the waste liquid crystal recycle container 103. The liquid crystal in the liquid crystal dispensing container 101 may be monitored by the measurement device 106, such as a resistance value measurement device, in the liquid crystal dispensing container 101 when the measurement device 106 indicates that the liquid crystal in the container 101 does not conform to the purity requirement, an instruction or signal opening the first valve assembly 123 and the second valve assembly 124 will be issued by the control system (not shown) of the depositing device. When the first valve assembly 123 and the second valve assembly are both open, the liquid crystal enters the waste liquid crystal recycle container 101 via the liquid crystal dropper, nozzle or conduit 116. When the liquid crystal depositing task is completed, an instruction will also be issued by the control system (not shown) of the depositing device to open the second valve assembly 124 and to close all of the pumps in the pipelines of the liquid crystal branch droppers or nozzles 117, and the residual liquid crystal is routed to the container 103 for recycling in the same manner as waste or contaminated liquid crystal through the liquid crystal dropper or nozzle 116.

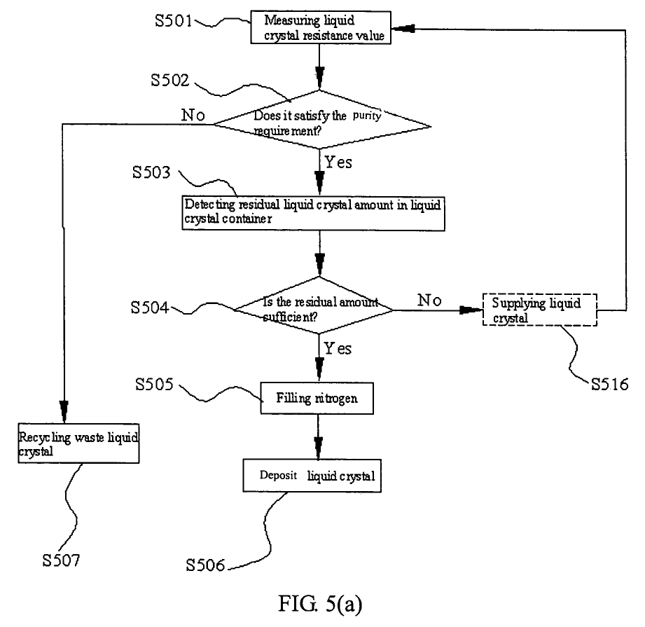

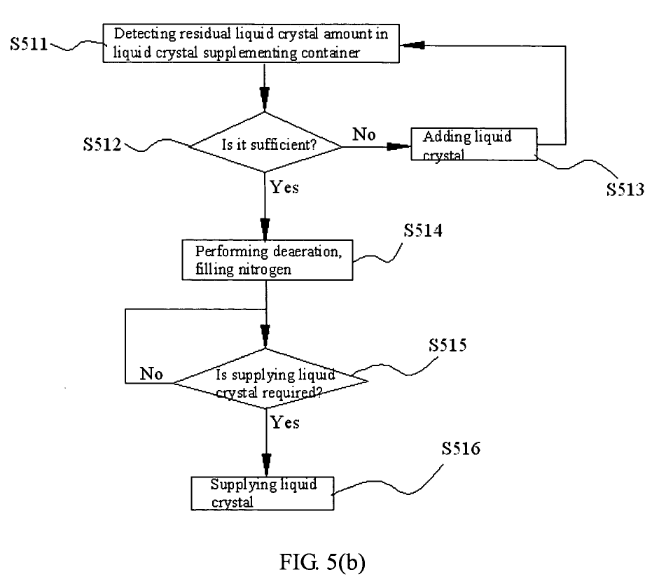

FIG. 5(a) and FIG. 5(b) are flow charts illustrating the depositing of the liquid crystal implemented by the liquid crystal dropping device of the present invention. Before the liquid crystal depositing device 100 of the present invention begins to operate, all of the valve assemblies are at a close state.

Firstly, the process of the liquid crystal depositing will be described referring to FIG. 5(a). In order to ensure that the liquid crystal to be deposited to the liquid crystal panel is liquid crystal conforming to the purity requirement, the measurement of the liquid crystal resistance is performed throughout the entire operation procedure of the device. That is, in step S501, the resistance of the liquid crystal in the liquid crystal dispensing container 101 is measured by the resistance value measurement device 106. In other embodiments, the purity of the liquid crystal is detected in other manners.

In step S502, a determination of whether the liquid crystal resistance value conforms to the purity requirement or not is implemented. If the liquid crystal conforms to the purity requirement, then the process will proceed to the next step S503, and the amount of residual liquid crystal in the liquid crystal dispensing container 101 will be detected by the first sensor 108. In contrast, if the liquid crystal does not conform to the requirement, then the process will proceed to step S507. At step S507, the operation of the entire device will be stopped, and the first and the second valve assemblies 123, 124 in the liquid crystal manifold 116 will be enabled to recycle the liquid crystal in the liquid crystal dispensing container 101.

In step S504, it is determined whether the residual liquid crystal in the liquid crystal dispensing container 101 is sufficient or not. For example, it may be determined that the amount or level of liquid crystal in the liquid crystal in the liquid crystal dispensing container is above a predetermined amount or level and, therefore sufficient. The predetermined amount or level may correspond to the amount or level required to be deposited onto a liquid crystal display substrate or batch or liquid crystal display substrates.

If the residual liquid crystal is sufficient, then the process will proceed to the next step S505, where the valve assembly 122 on the second gas supplying tube 114 will be opened to fill the inert gas, such as nitrogen, into the liquid crystal dispensing container 101. In contrast, if the residual liquid crystal is insufficient, then the process will proceed to step S516, where the valve assembly 127 will be opened to supply the liquid crystal to the liquid crystal dispensing container 101 via the liquid crystal supplementing container 102.

In step S506, the first valve assembly 123 of the liquid crystal dropper 116 is opened, and the pump (not shown) in each liquid crystal branch dropper or nozzle 117 is opened to deposit the liquid crystal to the liquid crystal panel or panels.

As described above, when it is detected that the residual liquid crystal amount in the liquid crystal dispensing container 101 is insufficient, the liquid crystal will be supplied to the liquid crystal dispensing container 101 by the liquid crystal supplementing container 102. For example, it may be determined that the amount or level of liquid crystal in the liquid crystal in the liquid crystal dispensing container is below a predetermined amount or level and, therefore insufficient.

The process of the liquid crystal supplying will be described by referring to FIG. 5(b) as follows.

In one embodiment, in order to ensure that sufficient liquid crystal is always maintained in the liquid crystal supplementing container 102 used for supplying the liquid crystal to the liquid crystal dispensing container 101 during the entire operation procedure of the device, the monitoring of the residual liquid crystal amount in the liquid crystal supplementing container 102 is optionally performed throughout the entire operation procedure.

In step S511, the residual liquid crystal amount in the liquid crystal dispensing container 101 is detected by the second sensor 109 of the liquid crystal supplementing container 102.

In step S512, it is determined whether the residual liquid crystal in the liquid crystal supplementing container 102 is sufficient or not. For example, it may be determined that the amount or level of liquid crystal in the liquid crystal in the liquid crystal supplementing container is above a predetermined amount or level and, therefore sufficient. The predetermined amount or level may correspond to the amount or level required to be deposited into the dispensing container to bring the level of liquid crystal in the dispensing container to a sufficient amount or level.

If the residual liquid crystal is sufficient, then the process will proceed to the next step S514, and the valve assembly 125 in the first vessel 111 will be opened to perform the deaeration process for the liquid crystal in the liquid crystal supplementing container 102; then the valve assembly 125 is closed and the valve assembly 126 of the first gas supplying tube 112 is enabled to fill the inert gas, such as nitrogen, into the liquid crystal supplementing container 102. The gas applies pressure on the liquid crystal to guide the liquid crystal in the liquid crystal supplementing container 102 to flow out. In contrast, if the liquid crystal is insufficient, then the process will proceed to step S513, where the seal lid 130 of the liquid crystal supplementing container 102 will be opened to add sufficient liquid crystal into the liquid crystal supplementing container 102, and the seal lid 130 will then be closed after completing the filling to seal the container 102 to inhibit contaminants from entering the container.

In step S515, it is determined whether supplying the liquid crystal to the liquid crystal dispensing container 101 is required or not.

If the determination is that supplying the liquid crystal to the liquid crystal dispensing container 101 is required, then the process will proceed to step 516, where the valve assembly 127 of the liquid crystal transferring tube 113 will be enabled, and the filtered liquid crystal will be supplied to the liquid crystal dispensing container 101 by the liquid crystal supplementing container 102. If the determination is that supplying the liquid crystal to the liquid crystal dispensing container 101 is not required, then the process will return to enter step S515 and will optionally continuously determine whether supplying the liquid crystal to the liquid crystal dispensing container 101 is required or not.

It can be understood easily, by comparing with the prior art, an embodiment of the present invention provides a liquid crystal supplementing container used for supplying the liquid crystal to the liquid crystal container. In the disclosed embodiment, the bottom portion of the liquid crystal supplementing container is connected with the liquid crystal container via the liquid crystal transferring tube, and opening or closing the pipelines is controlled by the corresponding valve assemblies. The first vessel or pipeline is disposed on the liquid crystal supplementing container and is connected between the vacuum pump and the space above the liquid crystal in the liquid crystal supplementing container, for deaerating the liquid crystal in the liquid crystal supplementing container. The first gas supplying tube is further disposed on the liquid crystal supplementing container and is connected between the gas supplying unit and the space above the liquid crystal in the liquid crystal supplementing container, used for supplying the inert gas to the liquid crystal supplementing container. An independent waste liquid crystal recycle container is also provided in an embodiment of the present invention for recycling the waste liquid crystal.

According to the above contents, a plurality of technical solutions are also involved in embodiments of the present invention, for example, the bottom portion of the liquid crystal dispensing container 101 can be designed as a bottom in an elliptical orbicular shape, the baffle for the liquid crystal transferred into the liquid crystal dispensing container 101 can be designed as a fine grid in the above embodiments, and the like. It is apparent to those skilled in the art that the modifications and variations of the above embodiments fall within the scope as claimed in the Claims of the present invention.

By using the liquid crystal depositing device and the depositing method of the same, because a liquid crystal supplementing container is provided, the liquid crystal can be supplemented to the liquid crystal container at the time when the residual liquid crystal amount in the liquid crystal container is insufficient or is about to become insufficient, so that the problem of changing the liquid crystal container repeatedly due to limitation of the capacity of the liquid crystal container can be solved. As a result, the production line can be run continuously and the productivity can be increased. In the illustrated embodiment, the design of the liquid crystal container has an upside down taper bottom structure that decreases the width of the bottom portion, so as to control the amount of residual liquid crystal and reduce the residual amount to achieve a cost savings. Furthermore, supplying the liquid crystal in a centralized manner, and depositing the liquid crystal simultaneously can be achieved by using a plurality of liquid crystal branch droppers or nozzles of the liquid crystal manifold.

What is claimed is:

1. A liquid crystal depositing device comprising:
a liquid crystal dispensing container for containing liquid crystal to be deposited onto a liquid crystal display substrate;
a liquid crystal nozzle for depositing the liquid crystal from said liquid crystal container to said liquid crystal display substrate;
a first sensor configured to monitor an amount of liquid crystal inside said liquid crystal dispensing container;
a liquid crystal supplementing container configured to supply liquid crystal to said liquid crystal dispensing container when said first sensor detects that the amount of liquid crystal in the dispensing container has fallen below a predetermined amount; and
a liquid crystal transferring tube for connecting said liquid crystal supplementing container with said liquid crystal dispensing container.

2. The liquid crystal depositing device as claimed in claim 1, wherein said first sensor comprises an inductor arranged on an internal surface of said liquid crystal dispensing container.

3. The liquid crystal depositing device as claimed in claim 1, further comprising a manifold that communicates liquid crystal from the dispensing container to said liquid crystal nozzle and a plurality of additional liquid crystal nozzles for depositing the liquid crystal simultaneously to a plurality of liquid crystal substrates.

4. The liquid crystal depositing device as claimed in claim 1, further comprising a purity measurement device configured to determine whether the liquid crystal contained in the liquid crystal dispensing container meets a purity requirement.

5. The liquid crystal depositing device as claimed in claim 4, wherein said purity measurement device comprises a resistance value measurement device which is disposed inside the liquid crystal dispensing container for testing whether the resistance value of the liquid crystal inside the liquid crystal dispensing container indicates that said purity requirement is met.

6. The liquid crystal depositing device as claimed in claim 1, further comprising a waste liquid crystal recycle container, which is connected with the liquid crystal dispensing container via said liquid crystal nozzle.

7. The liquid crystal depositing device as claimed in claim 6, wherein a first valve assembly for controlling the depositing of the liquid crystal and a second valve assembly for controlling the recycling of the liquid crystal are disposed on the liquid crystal nozzle.

8. The liquid crystal depositing device as claimed in claim 1, wherein said liquid crystal dispensing container has a bottom structure with a capacity which is smaller than that of the bottom structure having a column shape.

9. The liquid crystal depositing device as claimed in claim 8, wherein said bottom structure of the liquid crystal container comprises an upside down taper bottom structure.

10. The liquid crystal depositing device as claimed in claim 9, wherein a liquid crystal baffle is disposed in the liquid crystal container near an end of the liquid crystal transferring tube.

11. The liquid crystal depositing device as claimed in claim 10, wherein said baffle extends horizontally from the internal side wall of the liquid crystal container.

12. The liquid crystal depositing device as claimed in claim 2, wherein a second inductor is disposed on the internal side surface of the liquid crystal supplementing container for monitoring a residual liquid crystal amount in the liquid crystal supplementing container.

13. The liquid crystal depositing device as claimed in claim 12, wherein a seal lid is disposed on the upper portion of the liquid crystal supplementing container for sealing the liquid crystal supplementing container.

14. The liquid crystal depositing device as claimed in claim 3, wherein a pump for dispensing the liquid crystal is disposed on each of the liquid crystal nozzles.

15. The liquid crystal depositing device as claimed in claim 1, further comprising a filter disposed in line with the liquid crystal transferring tube.

16. The liquid crystal depositing device as claimed in claim 1, wherein a supply of gas is provided to the liquid crystal supplementing container by a first gas supply tube and the supply of gas is provided to the liquid crystal dispensing container by a second gas supply tube.

17. The liquid crystal depositing device as claimed in claim 16, wherein a pressure release valve is disposed in the second gas supply tube.

18. A liquid crystal depositing method comprising:
detecting an amount of liquid crystal in a liquid crystal dispensing container;
comparing the detected amount of liquid crystal in the liquid crystal dispensing container to a predetermined sufficient liquid crystal amount; and
supplementing the liquid crystal to said liquid dispensing crystal container when the liquid crystal amount in the liquid crystal dispensing container is below said predetermined sufficient liquid crystal amount, and depositing the liquid crystal onto a liquid crystal display substrate when the liquid crystal amount in the liquid crystal dispensing container is above said predetermined sufficient liquid crystal amount.

19. The method as claimed in claim 18, wherein said comparing comprises:
determining that the liquid crystal amount is above said predetermined sufficient liquid crystal amount when a surface level of the liquid crystal in the liquid crystal dispensing container is higher than a prescribed level; and
determining that the liquid crystal amount is below said predetermined sufficient liquid crystal amount when the surface level of the liquid crystal in the liquid crystal dispensing container is lower than the prescribed level.

20. The method as claimed in claim 19, further comprising:
measuring a resistance value of the liquid crystal in said liquid crystal dispensing container;
determining whether the liquid crystal in said liquid crystal dispensing container satisfies a purity requirement based on the measured resistance value; and
recycling the liquid crystal when the resistance value of said liquid crystal does not satisfy the purity requirement.

21. The method as claimed in claim 18, wherein the supplementing the liquid crystal to the liquid crystal dispensing container further comprises:
detecting an amount of liquid crystal in a liquid crystal supplementing container;
comparing the detected amount of liquid crystal in said liquid crystal supplementing container to a predetermined sufficient liquid crystal amount for the supplementing container; and
adding liquid crystal to said liquid crystal supplementing container when the detected liquid crystal amount in the liquid crystal supplementing container is below said predetermined sufficient liquid crystal amount for the supplementing container, and supplementing liquid crystal in said liquid crystal dispensing container with liquid crystal from said supplementing container when the detected liquid crystal amount in the liquid crystal dispensing container is below the predetermined liquid crystal amount for the liquid crystal dispensing container.

22. The method as claimed in claim 18, wherein the depositing of the liquid crystal comprises:
dispensing the liquid crystal simultaneously via a plurality of liquid crystal nozzles.
